(19) United States
(12) Patent Application Publication
(10) Pub. No.: US 2024/0417042 A1
(43) Pub. Date: Dec. 19, 2024

(54) IMAGING AND DISPLAY SYSTEMS FOR A BOAT

(71) Applicant: MasterCraft Boat Company, LLC, Vonore, TN (US)

(72) Inventors: David F. Ekern, Knoxville, TN (US); Erica C. Clark-Heinrich, Knoxville, TN (US); Michael M. Miller, JR., Loudon, TN (US); Stephen M. Barber, II, Knoxville, TN (US); Chad A. Lynema, Knoxville, TN (US); Daniel J. Tremaine, Nashville, TN (US)

(21) Appl. No.: 18/743,609

(22) Filed: Jun. 14, 2024

Related U.S. Application Data
(60) Provisional application No. 63/508,606, filed on Jun. 16, 2023.

(51) Int. Cl. B63B 34/75; B60R 1/12; B60R 1/26; B63H 21/21; G03B 17/56; G03B 30/00

(52) U.S. Cl. CPC B63B 34/75; B60R 1/26; B63H 21/213; G03B 17/561; G03B 30/00; B60R 1/12; B60R 2001/1253; B60R 2300/105; B60R 2300/70

(57) ABSTRACT

A boat includes at least one camera and a display screen communicatively coupled to the camera to selectively display images from the camera. The camera may be positioned on the boat to have a field of view of an environment external to a hull of the boat, such as a forward-facing camera positioned to have a field of view of an environment forward of the bow of the boat or an aft-facing camera positioned to have a field of view of an environment aft of the stern of the boat. In response to the selection of a user-selectable element configuring the boat for an activity, such as a water sport, or in response to an operation of a control, such as a reverse control, the display screen displays images from the camera, such as a live video feed from the camera.

### CROSS-REFERENCE TO RELATED APPLICATIONS

This application claims the benefit under 35 U.S.C. § 119 (e) of U.S. Provisional Patent Application No. 63/508,606, filed Jun. 16, 2024, and titled “IMAGING AND DISPLAY SYSTEMS FOR A BOAT,” the entirety of which is incorporated herein by reference.

### FIELD OF THE INVENTION

The invention relates to boats, particularly boats used for water sports.

### BACKGROUND OF THE INVENTION

Boats are used to tow water-sports participants, such as water skiers, wakeboarders, and the like, using a towline. For water skiing and wakeboarding, the participant holds onto one end of the towline and the other end is attached to the boat. For tubing, the towline is attached to the tube, and the water-sports participant(s) holds onto the tube. A boat may also be used to generate a wake on which a water-sports participant, such as a wake surfer or foiler, may wake surf or foil, generally without holding onto a towline once they get going. In each of these activities, the water-sports participant is located behind (aft) of the boat.

### SUMMARY OF THE INVENTION

In one aspect, the invention relates to a boat including at least one camera and a display screen communicatively coupled to the camera to selectively display images from the camera. The camera may be positioned on the boat to have a field of view of an environment external to a hull of the boat, such as a forward-facing camera positioned to have a field of view of an environment forward of the bow of the boat or an aft-facing camera positioned to have a field of view of an environment aft of the stern of the boat. In response to the selection of a user-selectable element configuring the boat for an activity, such as a water sport, or in response to an operation of a control, such as a reverse control, the display screen displays images from the camera. The camera may be a video camera and the images displayed may be a live feed from the camera.

In another aspect, the invention relates to a boat that includes a stern, a plurality of aft-facing cameras, a display screen, an input device, and a controller communicatively coupled to the input device and the display screen. Each aft-facing camera of the plurality of aft-facing cameras is positioned on the boat to have a field of view of at least an environment aft of the stern of the boat and configured to generate images of the environment aft of the stern of the boat. One camera of the plurality of aft-facing cameras is a port aft-facing camera positioned on a port side of centerline of the boat, and another camera of the plurality of aft-facing cameras is a starboard aft-facing camera positioned on a starboard side of centerline of the boat. The display screen is communicatively coupled to each of the port aft-facing camera and the starboard aft-facing camera to selectively display images from the port aft-facing camera and the starboard aft-facing camera. The input device includes at least one user-selectable element for a port-side water sport and at least one user-selectable element for a starboard-side water sport. The controller is configured to display, on the display screen, images from one of the port aft-facing camera or the starboard aft-facing camera. The controller is configured to display, on the display screen, (i) images from the port aft-facing camera when the at least one user-selectable element for the port-side water sport is selected, and (ii) images from the starboard aft-facing camera when the at least one user-selectable element for the starboard-side water sport is selected.

In a further aspect, the invention relates to a boat that includes a hull having a bow, a forward-facing camera, a control console including a display screen, an input device including at least one user-selectable element for a water sport, and a controller communicatively coupled to the input device and the display screen. The forward-facing camera is positioned on the boat to have a field of view of an environment forward of the bow of the boat and configured to generate images of the environment forward of the bow of the boat. The display screen is communicatively coupled to the forward-facing camera to selectively display images from the forward-facing camera. The controller includes a processor and a memory, and the controller is configured to display on the display screen, when the at least one user-selectable element for the water sport is selected, images from the forward-facing camera.

In a still another aspect, the invention relates to a boat that includes a stern, a propulsion system, a reverse control, an aft-facing camera, a display screen, and a controller communicatively coupled to the display screen. The propulsion system includes a motor and a propulsor. The motor is engageable with the propulsor to move the boat in an aft direction. The reverse control is operable to engage the motor with the propulsor to move the boat in an aft direction. The aft-facing camera is positioned on the boat to have a field of view of an environment aft of the stern of the boat and configured to generate images of the environment aft of the stern of the boat. The display screen is communicatively coupled to the aft-facing camera to selectively display images from the aft-facing camera. The controller is configured to display, on the display screen, images from the aft-facing camera when the reverse control is operated to engage the motor with the propulsor to move the boat in an aft direction.

These and other aspects of the invention will become apparent from the following disclosure.

### BRIEF DESCRIPTION OF THE DRAWINGS

FIG. 1 shows a boat according to a preferred embodiment of the invention.

FIG. 2 is a top view of the boat shown in FIG. 1.

FIG. 3 is a cross-sectional view, taken along line 3-3 in FIG. 2, of a stern of the boat shown in FIG. 1, showing a propulsion system of the boat.

FIG. 4 is a perspective view of a control console of the boat shown in FIG. 1.

FIG. 5 is a schematic diagram of a control system for the boat shown in FIG. 1.

FIG. 6 is a stern view of the boat shown in FIG. 1, showing positions of two aft-facing cameras and schematically illustrating the field of view of the two aft-facing cameras.

FIGS. 7A and 7B are images captured by the two aft-facing cameras shown in FIG. 6. FIG. 7A is an image captured by the port aft-facing camera, and FIG. 7B is an image captured by the starboard aft-facing camera.

FIG. 8 is a stern view of the boat shown in FIG. 1, showing a position of a tower-mounted aft-facing camera and schematically illustrating the field of view of the tower-mounted aft-facing camera.

FIG. 9 is an image captured by the aft-facing tower camera shown in FIG. 8.

FIG. 10 is a forward view of the boat shown in FIG. 1, showing a position of a tower-mounted forward-facing camera.

FIG. 11 is a side view of the bow of the boat shown in FIG. 1, showing possible positions of a bow-mounted forward-facing camera.

FIG. 12 is a perspective view of a control console of the boat shown in FIG. 1 with a mirror assembly including a display screen.

### DETAILED DESCRIPTION OF THE PREFERRED EMBODIMENTS

As used herein, directional terms forward (fore), aft, inboard, and outboard have their commonly understood meaning in the art. Relative to the boat, forward is a direction toward the bow, and aft is a direction toward the stern. Likewise, inboard is a direction toward the center of the boat, and outboard is a direction away from it.

The boat is operated by a driver (or operator) at a control console to move the boat through the water for water sports, such as those discussed above. When the boat is underway (or driven), the driver needs to look forward to operate the boat, keeping it on course and avoiding navigational hazards, such as other vessels or submerged or partially-submerged objects. But maintaining awareness of the boat operator's surroundings requires being aware of what is going on behind the boat as well, particularly when a water-sports participant is behind the boat.

A mirror can be used to help the driver see the water-sports participant. Typically, the boat will include just one mirror attached to the top edge of the windshield. Depending upon how the mirror is positioned, the mirror may be useful to see the water-sports participant when they are on one side of the boat, but it may be difficult to see the water-sports participant when they are on the other side because the water-sports participant may be directly behind the driver's head and the driver's reflection in the mirror may block the view of the water-sports participant. For example, when wake surfing on the starboard side of the boat, the water-sports participant may be located behind the driver's head, and thus the driver's head may block the view of the water-sports participant. Trying to see the water-sports participant requires the driver to move, making the driver uncomfortable after just a short amount of time. The driver may need to turn and look backwards, which results in the driver to taking his or her eyes off of looking forward.

In addition, for water sports such as wake surfing, the boat may have a high angle of attack due, at least in part, to ballasting in the rear of the boat. The bow is pitched upward, and this bow rise reduces visibility forward of the boat, making it difficult for the operator to see directly in front of the boat.

The embodiments described herein relate to systems and methods that can be used to improve the visibility and awareness for the driver of the environment surrounding the boat. The systems and methods discussed herein use one or more image sensors, cameras in preferred embodiments discussed herein, positioned on the boat and coupled to a display screen, such that images from these cameras (such as live feeds) can be displayed on the display screen. The display screen is preferably located at the control console to improve the visibility for the driver. These cameras are positioned on the boat to have fields of view of specific environments external to a hull of the boat. These fields of view and the images displayed on the display screens are specifically tailored to activities for which the boat is used. When the boat is configured for an activity, such as configured for a specific wake sport, or operated in a certain way, such as in reverse, images from select cameras are displayed on the display screen to provide the driver relevant images from these select cameras without over burdening the driver with extra, less relevant images for the activity.

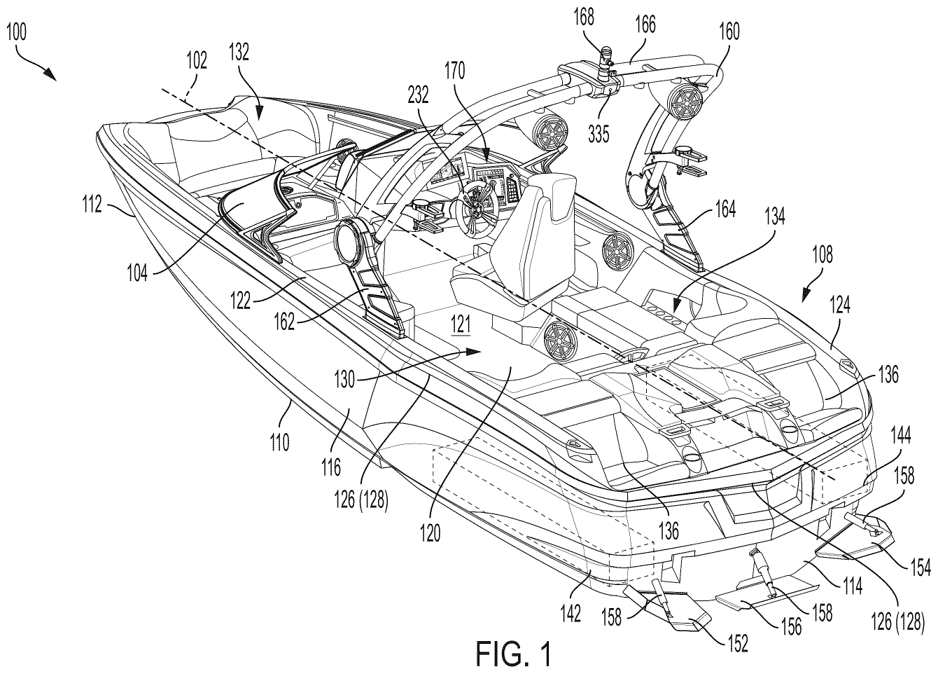

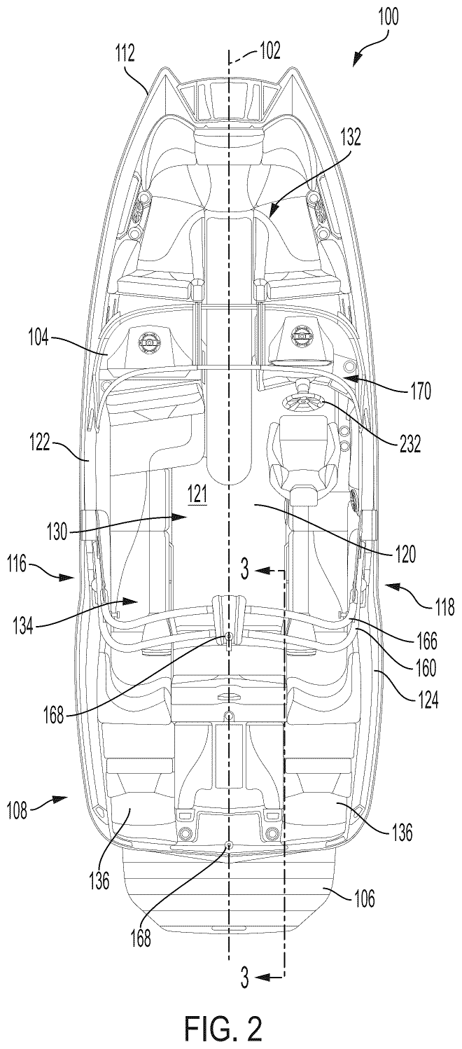

FIGS. 1 and 2 show a boat 100 in accordance with an exemplary preferred embodiment of the invention. The boat 100 includes a hull 110 with a bow 112, a transom 114, a port side 116, and a starboard side 118. The boat 100 has a deck 120 including a floor 121. The port and starboard sides 116, 118 have port and starboard gunwales 122, 124, respectively. In some embodiments, such as for fiberglass boats, the boat 100 can be formed from a hull molding, forming at least a portion of the hull 110, and a deck molding, forming at least a portion of the deck 120 and the floor 121. The top edge of the hull side, such as a top edge of the hull molding where the hull molding comes into contact with the deck molding, defines a sheerline 126 of the boat 100. The port and starboard gunwales 122, 124 can be a generally horizontal surface of the deck molding (generally horizontal deck surface). Alternatively, the port and starboard gunwales 122, 124 can be formed as part of the hull 110 and, more specifically, as part of the hull molding. The port and starboard gunwales 122, 124 can be a top perimeter surface of the deck 120 or hull 110. The boat 100 also can have a rub rail 128, which in some embodiments is positioned over the sheerline 126. The boat 100 has a centerline 102 running down the middle of the boat 100, halfway between the port and starboard sides 116, 118. Collectively, the bow 112, the transom 114, and the port and starboard sides 116, 118 define an interior 130 of the boat 100.

In the embodiment shown in FIGS. 1 and 2, the boat 100 is a bowrider having both a bow seating area 132 positioned in the bow 112 of the boat 100 and a primary seating area 134 (sometimes also referred to as the cockpit) positioned aft of a windshield 104. The boat 100 shown in FIGS. 1 and 2 also has a pair of aft-facing seats 136, such as those described in U.S. Pat. No. 9,650,117, which is incorporated by reference herein in its entirety. Although described in reference to a bowrider, this invention may be used with any suitable deck arrangement (boats), including cuddies, center consoles, or cruisers, for example. The invention is also not limited to boats with single decks but may also be used with other boats that have multiple decks, such as a flybridge. The invention discussed herein may also be used with pontoon boats and multi-hull boats.

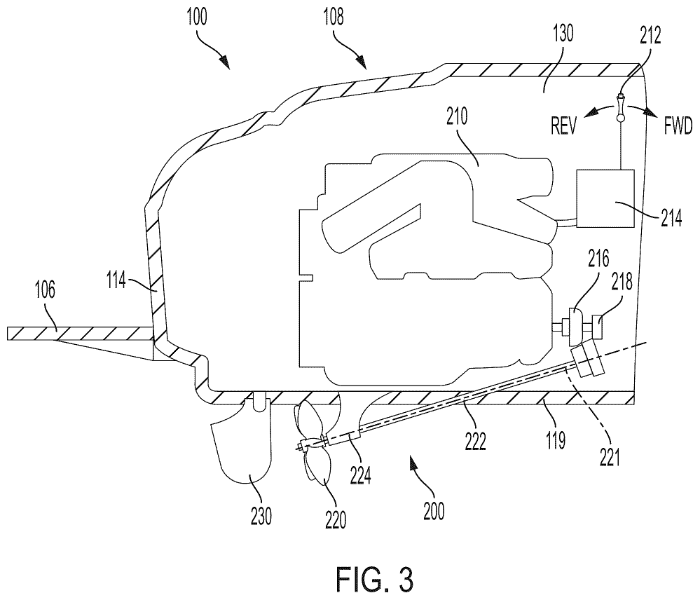

The boat 100 includes a horizontal swim platform 106 attached to the transom 114 to make it easier for people to get into the water from the boat 100 or into the boat 100 from the water. A top view of the swim platform 106 is shown in FIG. 2 (see also FIG. 3), but the swim platform is omitted from FIG. 1 for clarity. The swim platform 106 should be capable of supporting a human, and the swim platform 106 is preferably capable of supporting at least 500 lbs. and, even more preferably, 1250 lbs. The swim platform 106 may be constructed from any suitable material that may be used in a marine environment, including for example, fiberglass or teak. In this embodiment, the swim platform 106 is attached to the transom 114 of the boat 100 using two brackets screwed to the transom 114; however, the swim platform 106 may be attached to the transom 114 by any suitable means. While the swim platform 106 is described as an attachable/detachable platform, it is not so limited. For example, the swim platform 106 may be integrally formed with the stern 108 of the boat 100.

The boat 100 shown in FIG. 1 is a recreational boat and, more specifically, a recreational sport boat that may be used for water sports, such as water skiing, wakeboarding, wake surfing, wake foiling, and tubing. The boat 100 thus may be equipped with water sport accessories or systems to facilitate the use of the boat 100 with such activities. These water-sport accessories and systems include, for example, devices that interact with the water and are capable of enhancing or otherwise adjusting the wake produced by the boat 100 and tow points for towing water-sports participants.

The boat 100 may include the capability to add ballast. Ballast may be used to increase the weight and displacement of the boat 100 and increase the size of the wake for water sports, such as wakeboarding or wake surfing. Any suitable means to add ballast may be used, including ballast bags (sacks) or ballast tanks. The boat 100 shown in FIG. 1 includes three ballast tanks. The boat 100 includes a stern 108, and preferably, two ballast tanks are positioned in the stern 108 of the boat near the bottom of the hull, one on each side of the boat (a port ballast tank 142 and a starboard ballast tank 144), and a third ballast tank (not shown) is positioned along the boat's centerline near the bottom of the hull, forward of the two stern ballast tanks 142, 144. Ballast bags may be used in addition to the ballast tanks and may be plumbed into the ballast system of the boat 100. Preferably, the ballast bags are positioned above the stern ballast tanks 142, 144 in a compartment underneath the aft-facing seats 136. Both the ballast tanks and the ballast bags operate similarly in that water, such as water surrounding the boat 100, may be pumped into the tank or bag by ballast pumps 146 to add weight. The ballast tanks (e.g., the port ballast tank 142 and the starboard ballast tank 144) and the ballast bags are fluidly coupled to the water surrounding the boat 100 by ballast lines and through-hull fittings. Any suitable ballast system and arrangements tanks, bags, and the like may be used, including, for example, the ballast systems disclosed in U.S. Pat. No. 11,254,391, which is incorporated by reference herein in its entirety.

The boat 100 may be equipped with surf devices 152, 154, which may be used to shape the wake of the boat for wake surfing. Any suitable surf devices may be used, including, for example, the port and starboard wake-modifying devices disclosed in U.S. Pat. No. 8,833,286, which is incorporated by reference herein in its entirety. Each of the port and starboard surf devices 152, 154 includes a plate-like member that is pivotably attached to the transom 114 of the boat 100. The plate-like members pivot about pivot axes to move between at least one non-deployed position and at least one deployed position. The port and starboard surf devices 152, 154 may include a plurality of non-deployed and deployed positions. In this embodiment, the pivot axes are hinges. Here, the hinges are piano hinges that are welded to a leading portion of each plate-like member and attached to the transom 114 of the boat 100 using screws. However, any suitable pivotable connection may be used and may be affixed to the transom 114 of the boat 100 and the port and starboard surf devices 152, 154 using any suitable means, including but not limited to bolts, screws, rivets, welding, and epoxy. Each of the port and starboard surf devices 152, 154 also may include one or more downturned and/or upturned surfaces, such as downturned surfaces at the trailing edge of the plate-like members that are angled at a downward angle relative to the plate-like member. However, as noted above, any suitable surf device may be used, and other suitable surf devices may include, for example, the port and starboard wake-modifying devices disclosed in U.S. Pat. No. 9,802,684, which is incorporated by reference herein in its entirety, and the surf devices disclosed in U.S. Patent Application Publication No. US 2022/0089258, which is incorporated by reference herein in its entirety.

As shown in FIG. 1, the boat 100 is also equipped with a central trim device (center tab 156) positioned to span the centerline 102 of the boat. Any suitable trim device may be used, but in this embodiment, the center tab 156 is a generally rectangular trim tab that is pivotably attached to the transom 114 of the boat 100. The center tab 156 includes a plate-like member and pivots about a pivot axis to move between at least one non-deployed position and at least one deployed position. The center tab 156 may have a plurality of non-deployed and deployed positions. Like the pivot axes of the surf devices 152, 154, the pivot axis of the center tab 156 may be any suitable pivotable connection affixed to the transom 114 of the boat 100. However, as noted above, any suitable surf device may be used, and other suitable surf devices may include, for example, the center wake-modifying devices disclosed in U.S. Pat. No. 10,358,189, which is incorporated by reference herein in its entirety.

Each of the surf devices 152, 154 and the center tab 156 is movable between the deployed position and the non-deployed position by a drive mechanism 158. In the embodiment shown, one drive mechanism 158 is used for each surf device 152, 154 and the center tab 156, allowing them to be independently operated. Each of the drive mechanisms 158 shown in this embodiment is a linear actuator. The linear actuator may be an electric linear actuator or an electro-hydraulic actuator (EHA). A suitable electric linear actuator may be one from Lenco Marine of Stuart, Florida, and a suitable electro-hydraulic actuator (EHA) may be one available from Parker Hannifin of Marysville, Ohio. One end of the linear actuator is connected to the transom 114 of the boat 100, and the other end is connected to the surf device 152, 154 or center tab 156. Any suitable means may be used to move the surf devices 152, 154 and the center tab 156 between the deployed and non-deployed positions, including but not limited to hydraulic linear actuators, gas assist pneumatic actuators, and electrical motors.

The boat 100 is also equipped with an apparatus for towing a water-sports participant. As shown in FIGS. 1 and 2, the towing apparatus is a tower 160 that is particularly used for towing a wakeboarder. Any suitable tower 160 may be used, including, for example, those described in U.S. Pat. Nos. 9,580,155 and 10,150,540, which are incorporated by reference herein in their entireties. The tower 160 includes two legs: a port leg 162 and a starboard leg 164. The port leg 162 is attached to the boat 100 on the port side of the centerline 102 of the boat 100, and the starboard leg 164 is attached to the boat 100 on the starboard side of the centerline 102 of the boat 100. Preferably, the port and starboard legs 162, 164 are attached to the port gunwale 122 and to the starboard gunwale 124, respectively. The tower 160 also includes a header 166. The header 166 is connected to an upper portion of each of the two legs 162, 164 and spans the interior 130 of the boat 100 at a height suitable for passengers to pass underneath while standing. In addition, the tower 160 has a towline-attachment structure 168 at an upper portion of the tower 160 (the header 166 in this embodiment). This towline-attachment structure 168 may be used to connect a towline suitable for towing a water-sports participant, such as a wakeboarder. Any suitable towline-attachment structure may be used, including but not limited to the integrated light and towline-attachment assembly disclosed in U.S. Pat. No. 6,539,886, which is incorporated by reference herein in its entirety. Additionally or alternatively, towline-attachment structures 168 may be located elsewhere on the boat, such as on the transom 114 or a portion deck in the stern 108. Such lower towline-attachment structures 168 are preferably used for water sports like tubing.

FIG. 3 is a cross-sectional view, taken along line 3-3 in FIG. 2, of a stern 108 of the boat 100 shown in FIG. 1, showing a propulsion system 200 of the boat 100. The boat 100 of this embodiment is an inboard boat. However, this invention can be utilized with other types of boats and propulsion systems, including but not limited to outboard motors, sterndrives, jet drives, and the like. The propulsion system 200 includes a motor operatively coupled to a propulsor to drive the propulsor. In this embodiment, the motor is a combustion engine 210, but other suitable motors may be used, including electrical motors. The propulsor of this embodiment is a propeller 220, but other suitable propulsors may be used, such as, for example, impellers in jet drives. The engine 210 is configured to drive (rotate) the propeller 220, and in this embodiment, the engine 210 is connected to the propeller 220 by a drive shaft 222. The engine 210 is located within the interior 130 of the boat 100, and the drive shaft 222 extends through the hull bottom 119. The engine 210 is coupled to the drive shaft to rotate the drive shaft 222, and thus the propeller 220. The drive shaft 222 rotates about a rotation axis 221 of the drive shaft 222. A strut 224 extends from the hull bottom 119 to support the drive shaft 222 and the propeller 220. The drive shaft 222 extends through a bushing in the strut 224. The propeller 220 is positioned beneath the hull bottom 119 and forward of the transom 114. The propulsion system 200 of this embodiment, specifically, the engine 210 and the drive shaft 222, is arranged in a V-drive arrangement, allowing the engine 210 to be located aft in the stern 108 of the boat 100 and further increasing the displacement of the stern 108 of the boat 100 for water sports, such as wake surfing or wake boarding. The propulsion system 200 may be arranged in other inboard arrangements, such as a direct drive arrangement, which may be preferred for water ski boats where increased displacement is not desired.

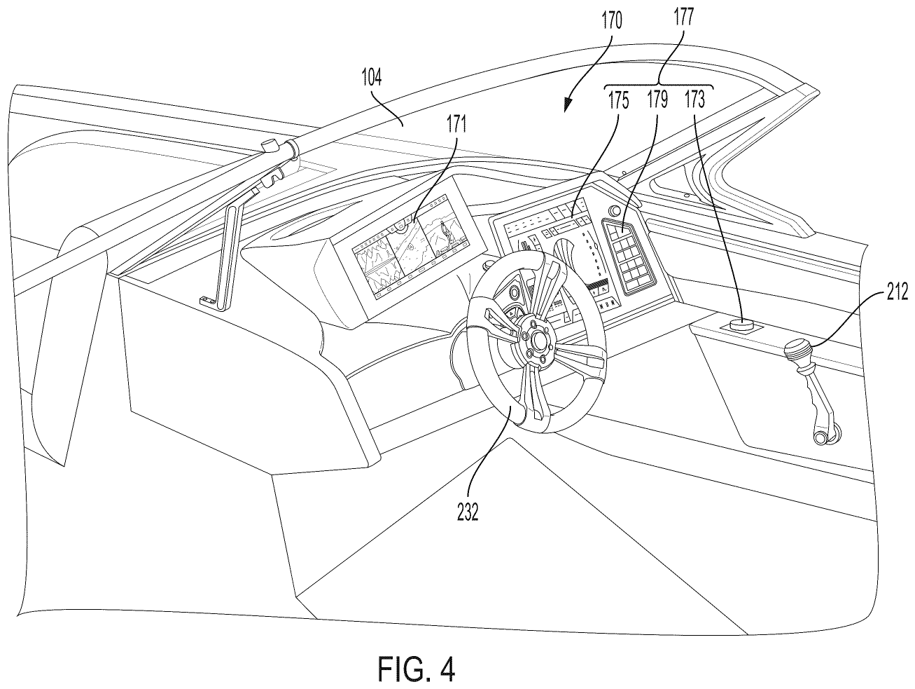

A rudder 230 for turning the boat 100 is positioned behind (aft of) the propeller 220. A user may turn the boat 100 by rotating a steering wheel 232 (see FIG. 4) located at a control console 170 (see FIG. 4) of the boat 100. The steering wheel 232 is coupled to the rudder 230 such that turning the steering wheel 232 rotates the rudder 230. Any suitable steering system may be used, including mechanical rack-and-pinion systems connected to the rudder by mechanical linkages, hydraulic steering systems, electronic steering systems, or the rudder system shown and described in U.S. Pat. No. 9,611,009, which is incorporated by reference herein in its entirety. In other embodiments, for example, the steering wheel 232 may rotate a marine drive of an outboard or sterndrive or a nozzle of a jet drive when these other propulsions systems are used.

In this embodiment, the engine 210 and the propeller 220 may be operated by a user at the control console 170 (discussed further below with reference to FIG. 4). The control console 170 may include a forward control operable to engage the motor with the propulsor to move the boat in a forward direction and a reverse control operable to engage the motor with the propulsor to move the boat in an aft direction. Although other suitable forward and reverse controls may be used, such as buttons or switches, the forward and reverse control in this embodiment is a control lever 212 that operates a throttle 214 of the engine 210 and engages the engine 210 with the drive shaft 222. The control lever 212 has a neutral position, a plurality of forward positions, and a plurality of reverse positions. The user may move the control lever 212 forward from the neutral position and into a forward position to engage a running gear 216 with the drive shaft 222, accelerate the engine 210 using the throttle 214, and rotate the propeller 220 in a first direction, such as counterclockwise, to drive the boat 100 forward. To move the boat 100 in reverse, the user may move the control lever 212 back from the neutral position and into a reverse position to engage a reverse gear 218 with the drive shaft 222, accelerate the engine 210 using the throttle 214, and rotate the propeller 220 in a second direction opposite the first direction, such as clockwise. Any suitable means may be used to operate the engine 210 and engage it with the drive shaft 222. The plurality of forward positions and the plurality of reverse positions each correspond to different motor speeds, and each of the forward and reverse positions controls the propulsion system 200, and more specifically the motor (such as the engine 210), to run at different speeds. In the depicted embodiment, pushing the control lever 212 further forward (or further in reverse) from the neutral position opens the throttle 214 further and moving the control lever 212 back towards the neutral position closes the throttle 214.

FIG. 4 shows the control console 170 for operating the boat 100. Here, the control console 170 is positioned on the starboard side of the boat 100 proximate to and aft of the windshield 104 (see FIGS. 1 and 2). The control console 170 is used to support and enclose various controls for operating the boat 100. As noted above, the steering wheel 232 and the control lever 212 are located at the control console 170. The control console 170 may also include at least one display screen. In this embodiment, the control console 170 includes two display screens, a center display 171 and a side display 175.

The center display 171 may be positioned and oriented so that the operator can be aware of the information displayed on the center display 171 without substantially deviating his or her attention from the boat's heading. In this embodiment, for example, the center display 171 is located at the top of the dash forward of the steering wheel 232 and above the steering column of the steering wheel 232 so that the operator is able to view the information displayed on the center display 171 without turning his or her head. Although the center display 171 may be a touchscreen, the center display 171 in this particular embodiment is not because of the positioning of the center display 171 and the type of information displayed on it. The positioning of the center display 171 makes it difficult or awkward for a user to reach with his or her hand, so to the extent that user-selectable options are displayed on the center display 171, they may be selected by using a section knob 173, switch pad, or another suitable input device (user interface). In this embodiment the center display 171 is a rectangular 15-inch screen.

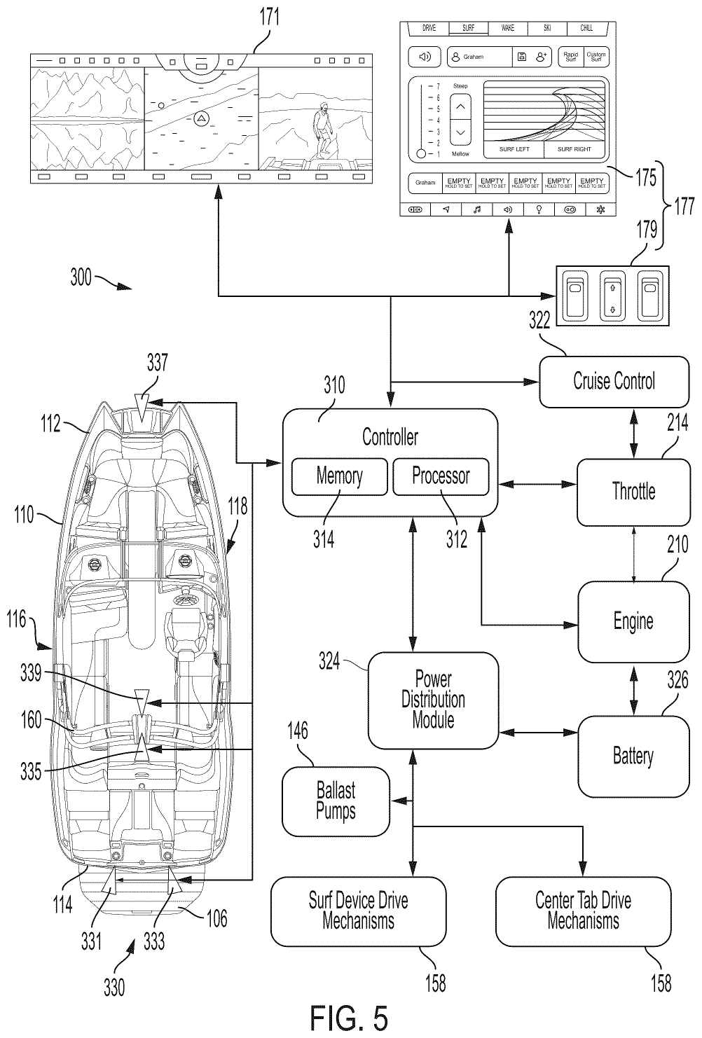

The control console 170 includes input devices 177 that are used to select various functions or options and operate various features and systems of the boat. Such input devices 177 may be operator controls. Many of the input devices 177 on the boat 100 may be conveniently located on the control console 170 to the side of the steering wheel 232. In this embodiment, the input devices 177 are located on the outboard side of the steering wheel 232 and can be conveniently operated by the operator's right hand. One of the main input devices 177 in this embodiment is the side display 175. In this embodiment, the side display 175 is a 15 inch, rectangular, touchscreen display, and a plurality of user-selectable elements (controls) are displayed on the side display 175. The plurality of user-selectable options are icons displayed on the side display 175 that may be selected by a user pressing the icon. The terms icon, virtual button, and button will be used interchangeably herein to describe these and other user-selectable options displayed by a controller 310 (see FIG. 5) on the side display 175. When a user-selectable option is selected or activated, the side display 175 generates an output or signal that is transmitted to the controller 310, for example. Other input devices 177 (controls) may include other static buttons and switches that are part of, for example, a switch pack 179. These static buttons and switches are another example of user-selectable elements (controls).

FIG. 5 is a schematic diagram of the control system 300 for the boat 100 shown in FIG. 1. Various features of the control system 300 may also be seen in FIG. 4. The control system 300 includes a controller 310. In this embodiment, the controller 310 may be a computing device having one or more processors 312 and one or more memories 314. The processor 312 can be any suitable processing device, including, but not limited to, a microprocessor, a microcontroller, an integrated circuit, a logic device, a programmable logic controller (PLC), an application-specific integrated circuit (ASIC), and/or a Field Programmable Gate Array (FPGA). The memory 314 can include one or more computer-readable media, including, but not limited to, non-transitory computer-readable media, a computer-readable non-volatile medium (e.g., a flash memory), a RAM, a ROM, hard drives, flash drives, and/or other memory devices.

The memory 314 can store information accessible by the processor 312, including computer-readable instructions that can be executed by the processor 312. The instructions can be any set of instructions or a sequence of instructions that, when executed by the processor 312, causes the processor 312 and the controller 310 to perform operations. In some embodiments, the instructions can be executed by the processor 312 to cause the processor 312 to complete any of the operations and functions for which the controller 310 is configured, as will be described further below. The instructions can be software written in any suitable programming language or can be implemented in hardware. Additionally or alternatively, the instructions can be executed in logically and/or virtually separate threads on the processor 312. The memory 314 can further store data that can be accessed by the processor 312.

The technology discussed herein makes reference to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between components and among components. For instance, processes discussed herein can be implemented using a single computing device or multiple computing devices working in combination. Databases, memories, instructions, and applications can be implemented on a single system or distributed across multiple systems. Distributed components can operate sequentially or in parallel.

In this embodiment, the controller 310 is a microprocessor-based controller that includes the processor 312 for performing various functions discussed further below, and the memory 314 for storing various data. The various methods discussed below may be implemented by way of a series of instructions stored in the memory 314 and executed by the processor 312. The controller 310 is communicatively coupled to the input devices 177 to receive input from the input devices 177, and in response to input received from the input devices 177, the controller 310 is configured to operate various systems of the boat 100. The following examples will reference inputs from the side display 175, but the control system 300 and, more specifically, the controller 310 may be equally responsive to inputs from other input devices 177, such as the switch pack 179. Additionally, the systems described below may also be implemented without the use of a controller 310, such as by direct electrical connection for example.

The boat 100 may include a cruise control system 322. The side display 175 may include a cruise control button, and when the cruise control button is selected, the controller 310 receives a signal from the side display 175 to activate the cruise control, if off, or deactivate the cruise control, if already on. When a user selects the cruise control button to turn cruise control on, the controller 310 activates the cruise control system 322 at the set speed stored in the memory 314 of the controller 310 or in the cruise control system 322. Any suitable cruise control system 322 may be used including, for example, GPS-based Zero Off® cruise control by Enovation Controls of Tulsa, Oklahoma, in which the cruise control system 322 operates the throttle 214 of the engine 210 to maintain the boat 100 at the set speed based on the speed of the boat received by GPS as part of the cruise control system 322. Although shown as a separate system, one or more features of the cruise control system 322 may be implemented in the controller 310. A user can adjust the set speed of the cruise control by using, for example, an up-arrow button or a down-arrow button on the side display 175. The up-arrow button is used to the increase the set speed, and the down-arrow button is used to decrease the set speed.

The side display 175 may also include user-selectable options relating to ballast. Such user-selectable options may include ballast fill buttons and ballast empty buttons. Other user-selectable options may be used to fill or empty the ballast (e.g., the port ballast tank 142 and the starboard ballast tank 144) and set the ballast at desired levels. When a user-selectable option is selected that fills or otherwise adds water to the ballast, the controller 310 receives a command to fill or add water to the ballast (e.g., the port ballast tank 142 and the starboard ballast tank 144) and sends a signal to a power distribution module (PDM) 324 to provide power to the ballast pumps 146 for a predetermined amount of time to fill the ballast (e.g., the port ballast tank 142 and the starboard ballast tank 144). In response, the power distribution module 324, which is electrically coupled to a battery 326 on the boat 100, receives electrical power from the battery 326 and then transmits power to the ballast pumps 146 to add water (fill) the ballast (e.g., the port ballast tank 142 and the starboard ballast tank 144). Similarly, when a user-selectable option is selected that empties or otherwise removes water from the ballast, the controller 310 receives a command to empty or remove water from the ballast (e.g., the port ballast tank 142 and the starboard ballast tank 144) and sends a signal to the power distribution module 324 to provide power to the ballast pumps 146. In response, the power distribution module 324 powers the ballast pumps 146 to remove water (empty) from the ballast (e.g., the port ballast tank 142 and the starboard ballast tank 144). A user may also manually fill or empty the ballast (e.g., the port ballast tank 142 and the starboard ballast tank 144) using a switch in the switch pack 179 in a similar manner as discussed above.

The side display 175 may also include user-selectable options for positioning the center tab 156, and the surf devices, such as the port surf device 152 and the starboard surf device 154. When a user selects a user-selectable option to deploy or retract one or more of the surf devices 152, 154 or center tab 156, the controller 310 moves the port surf device 152, the starboard surf device 154, and/or center tab 156 to the desired deployed position (to the extent it is not already in the desired deployed position) by sending a signal to the power distribution module 324, which in turn provides power to the drive mechanism 158 of the corresponding port surf device 152, starboard surf device 154, and/or center tab 156 to move the port surf device 152, the starboard surf device 154, and/or the center tab 156.

In addition to individual controls, the side display 175 may include at least one user-selectable option that configures the boat 100 for a particular wake sport. The configuration of the boat 100 corresponding to each of the user-selectable options that will be described below may be stored in the memory 314. When a command is received from the side display 175 indicating that a particular water sport configuration (pre-programmed setting for a water sport or profile) has been selected, the controller 310 retrieves the settings for the configuration and operates various components to configure the boat 100 according to the settings. For the water sports discussed herein, the settings stored in the memory 314 will typically be a set speed for the cruise control, the water level in the ballast (e.g., the port ballast tank 142 and the starboard ballast tank 144), and the positions of the surf devices 152, 154 and the center tab 156. Thus, these commands (user-selectable elements) are used to configure the boat for a particular water sport (e.g., surfing on the port side of the boat, surfing on the starboard side of the boat) or activity. The controller 310 will operate these components as discussed above when a particular configuration is selected.

Although the user-selectable options, including the pre-programmed settings for a water sport, can be arranged in various different ways, the controls in embodiments discussed herein are dynamic controls implemented using a plurality of modes. The side display 175, in concert with the center display 171, enables the use of dynamic controls. Instead of providing user-selectable options for every major feature of the boat on the side display 175 (and/or center display 171), the user-selectable controls displayed on the side display 175 and the corresponding information presented on the center display 171 are dynamic and change depending upon how the boat is currently being used and which mode is selected. This dynamic control system thus provides a user-friendly interface for operating the boat 100. Such dynamic controls and corresponding systems include, for example, those described in U.S. Pat. No. 11,048,469, which is incorporated by reference herein in its entirety.

The control system 300 may include a plurality of modes. Each different mode corresponds to a different activity, and each mode includes a plurality of controls corresponding to the activity of the mode. The plurality of controls of each mode is a subset of the major controls of the boat. The plurality of modes may include at least one water-sport mode (also referred to as tow modes) and at least one non-sport mode. The input devices 177, such as the side display 175, may include a mode selector, such as a mode button corresponding to each mode. As discussed below, one of the modes may be a default mode that is active upon start up and a user can change between the various modes, by selecting one of the mode buttons corresponding to the desired mode. The controller 310 may also be configured to automatically switch between modes. For example, the controller 310 may automatically switch from the chill mode to the drive mode when the speed of the boat exceeds a predetermined speed.

The water-sport modes may include, for example, a surf mode corresponding to wake surfing or foiling, a wakeboarding mode corresponding to wakeboarding, and/or a ski mode corresponding to water skiing. The sport modes are not so limited, however, and may correspond to other water sports (activities) such as tubing, for example.

The non-sport modes may include a drive mode, which is a default mode for operating the boat and moving it through the water (e.g., point to point operation), and a chill mode, which corresponds to boating activities when the boat 100 is not moving through the water. For present purposes, the boat 100 is considered as not moving through the water when it is not being propelled through the water by the propulsion system 200, and the phrase not moving through the water is not intended to exclude conditions were the boat 100 is moving through the water from other conditions, such as where the boat 100 is floating and being moved by wind, currents, or the like. Boating activities when the boat 100 is not moving through the water include, for example, swimming, sunbathing, grilling, or otherwise relaxing (“chilling”). The boat 100 is typically used for these activities when the boat 100 is anchored, moored to the dock, positioned on a sandbar or beach, or otherwise floating in the body of water without being propelled by the propulsion system 200.

Each water-sport mode may include at least one pre-programmed setting for the water sport of the mode. In the surf mode, for example, the pre-programmed settings may be referred to as surf profiles and in this embodiment a plurality of surf profiles may be used. Such surf profiles may include one or more profiles for surfing on the port side of the boat (“surf left”) and/or one or more profiles for surfing on the starboard side of the boat (“surf right”). When a surf left profile is selected, the port side of the boat 100 is a surf side of the boat 100 and the starboard side of the boat 100 is a non-surf side of the boat 100. When a surf right profile is selected, the starboard side of the boat 100 is the surf side and the port side of the boat 100 is the non-surf side.

For each of the wake surf configurations discussed herein, each ballast tank 142, 144, is preferably set at 100% full. However, other suitable fill conditions may be appropriate, including, for example, filling the ballast tank 142, 144 on the surf side (e.g., port ballast tank 142 for surf left profiles and the starboard ballast tank 144 for surf right profiles) more than the ballast tank 142, 144 on the non-surf side. The set speed for the cruise control is a speed suitable for surfing, preferably between 9 mph to 12 mph. The controller 310 will also deploy one of the surf devices 152, 154 used for creating a surf wake for a surfer. When the surf devices discussed in U.S. Pat. No. 8,833,286 are used, for example, the starboard surf device 154 is deployed in response to the controller 310 receiving a command from a user selecting a surf left profile, and the port surf device 152 is deployed in response to the controller 310 receiving a command from a user selecting a surf right profile. When the surf devices 152, 154 discussed in the fourth through the seventh embodiments of U.S. Patent Application Publication No. 2015/0175242 are used, the port surf device 152 is deployed in response to the controller 310 receiving a command from a user selecting a surf left profile, and the starboard surf device 154 is deployed in response to the controller 310 receiving a command from a user selecting a surf right profile. In addition to the position of the surf devices 152, 154, in some surf wake configurations, the center tab 156 may also be positioned.

The wakeboarding mode includes at least one pre-programmed setting (user-selectable element/option) for wakeboarding, which is referred to herein as a wakeboarding profile. Although the wake surf devices 152, 154 and the center tab 156 may be used in the wakeboarding profile, each of these devices are fully retracted in the wakeboarding profile of this embodiment. The wakeboarding profile includes a set speed of the boat, which is preferably from 18 mph to 25 mph. The wakeboarding profile may also include a ballast setting for the ballast. In general, a heavier boat is preferred for wake boarding and thus the ballast setting preferably includes adding water to the ballast tanks (e.g., the port ballast tank 142 and the starboard ballast tank 144). Suitable ballast levels include ballast levels greater than 30% such as from 30% to 60%, and from 70% to 100%.

The ski mode includes at least one pre-programmed setting (user-selectable element/option) for water skiing, which is referred to herein as a ski profile. Unlike the configurations of the boat for wake surfing and wakeboarding, water skiers generally prefer to minimize the wake. The settings associated with the ski profile may include no ballast and both surf devices 152, 154 fully retracted. For some ski profiles, the center tab 156 also may be fully retracted, but other ski profiles may deploy the center tab 156 to provide lift to the stern of the boat and help minimize the wake. The ski profile also may include a set speed that is preferably from 28 mph to 36 mph.

The profiles discussed herein (e.g., surf profiles, wakeboarding profiles, and ski profiles) may also include user-defined configurations. The side display 175 may thus include buttons that allow a user to save a current configuration of the boat 100 as a profile or to otherwise create a new profile.

The boat 100 discussed includes at least one camera 330, and in the embodiments discussed herein, a plurality of cameras 330 positioned on the boat 100. The plurality of cameras 330 are shown schematically in FIG. 5 and the position on the boat 100 of each of these cameras will be described in more detail below. The boat 100 includes at least one aft facing camera, and in this embodiment, a plurality of aft-facing cameras: a port aft-facing camera 331, a starboard aft-facing camera 333, and a central aft-facing camera (also referred to herein as an aft-facing tower camera 335). The boat 100 also includes at least one forward-facing camera, such as a bow camera 337 or a forward-facing tower camera 339. In the following discussion, the bow camera 337 and the forward-facing tower camera 339 are described as alternatives, but a plurality of forward-facing cameras could be used, such as both the bow camera 337 and the forward-facing tower camera 339. Each of the cameras 330 described herein can be a video camera that senses visual light to create video images.

Each of these cameras 330 is communicatively coupled to a display screen and, more specifically in this embodiment, the center display 171. In this embodiment, the cameras 330 are communicatively coupled to the center display 171 via the controller 310. The cameras 330 may be communicatively coupled to the controller 310 and center display 171 using any suitable means. In this embodiment, the cameras 330 are coupled to the controller 310 and center display 171 with a wired connection, but other suitable connections may be used, such as wireless connections. Suitable connections include, for example, an electrical conductor, a low-level serial data connection, such as Recommended Standard (RS) 232 or RS-485, a high-level serial data connection, such as Universal Serial Bus (USB) or the Institute of Electrical and Electronics Engineers (IEEE) 1394, a parallel data connection, such as IEEE 1284 or IEEE 488, and/or a short-range wireless communication channel, such as BLUETOOTH, and/or wireless communication networks using radiofrequency signals, such as Wi-Fi. When a wired connection and protocol is used, each of the cameras 330, the controller 310, and the center display 171 may include a suitable port to support the wired connection. When a wireless protocol is used, each of the cameras 330, the controller 310, and the center display 171 may include a transmitter and/or a receiver.

The controller 310 is configured to selectively display on the center display 171 images from one or more of the cameras 330. The cameras 330 discussed herein are video cameras, and thus the images displayed on the center display 171 are live (real time) feeds from the cameras 330. As noted above, the cameras 330 are used to improve the visibility and awareness for the driver of the environment surrounding the boat 100. These cameras 330 are positioned to provide views of certain portions of the environment surrounding the boat 100 that are obstructed or otherwise difficult to see when the boat 100 is being used in a particular manner, such as for water sports, and thus the controller 310 is configured to select the cameras 330 displayed on the center display 171 based on the operation of the boat, such as based on the selection of a user-selectable option for an activity. In the embodiments discussed herein, the user-selectable option for an activity may be the water sport profiles and/or the modes discussed above.

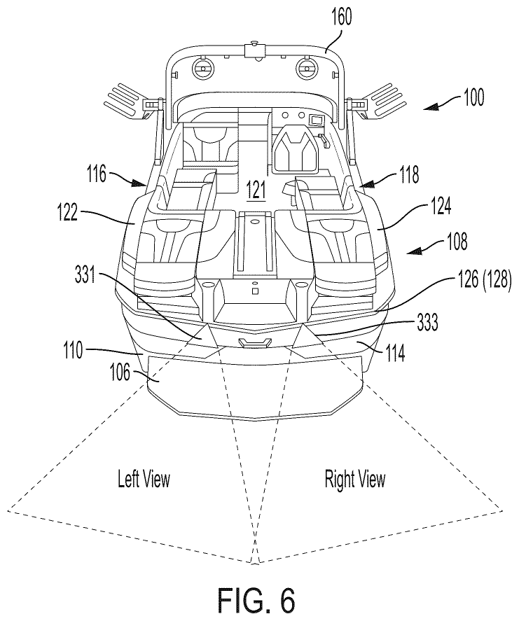

FIG. 6 is a stern view of the boat 100, showing the port aft-facing camera 331 and the starboard aft-facing camera 333 mounted on the boat 100. FIG. 6 also schematically illustrates the field of view of the port aft-facing camera 331 and the starboard aft-facing camera 333. Each of the port aft-facing camera 331 and the starboard aft-facing camera 333 is positioned on the boat 100 to have a field of view of an environment aft of the stern 108 of the boat 100 and configured to generate images of the environment aft of the stern 108 of the boat 100. The port aft-facing camera 331 is positioned on a port side of the boat 100 and positioned on the port side of the centerline 102. The starboard aft-facing camera 333 is positioned on a starboard side of the boat 100 and positioned on the starboard side of the centerline 102. In this embodiment, the port aft-facing camera 331 is positioned to provide images of a water-sports participant engaging in a water sport on the port side of the boat 100, and the starboard aft-facing camera 333 is positioned to provide images of a water-sports participant engaging in a water sport on the starboard side of the boat 100. Such water sports include, for example, wake surfing or foiling.

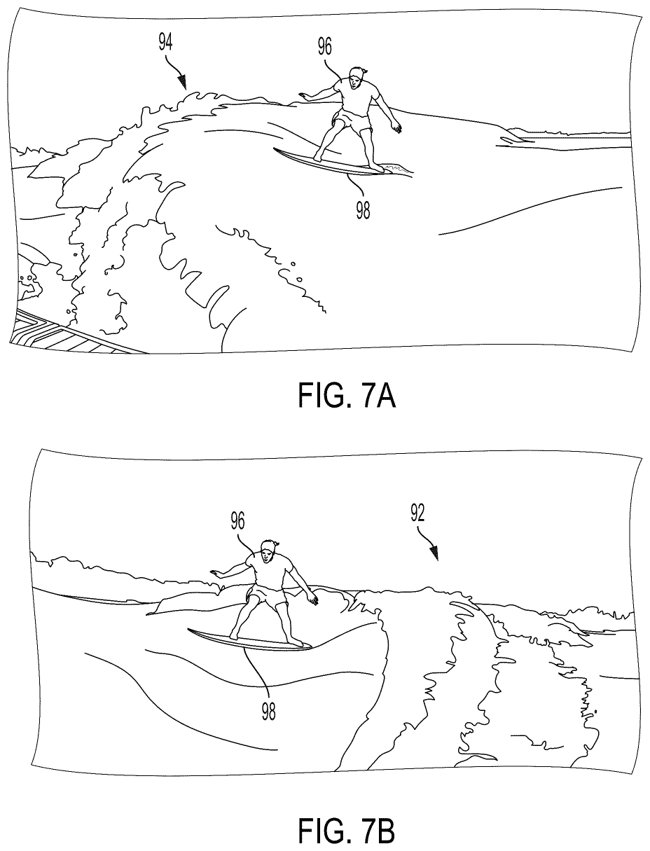

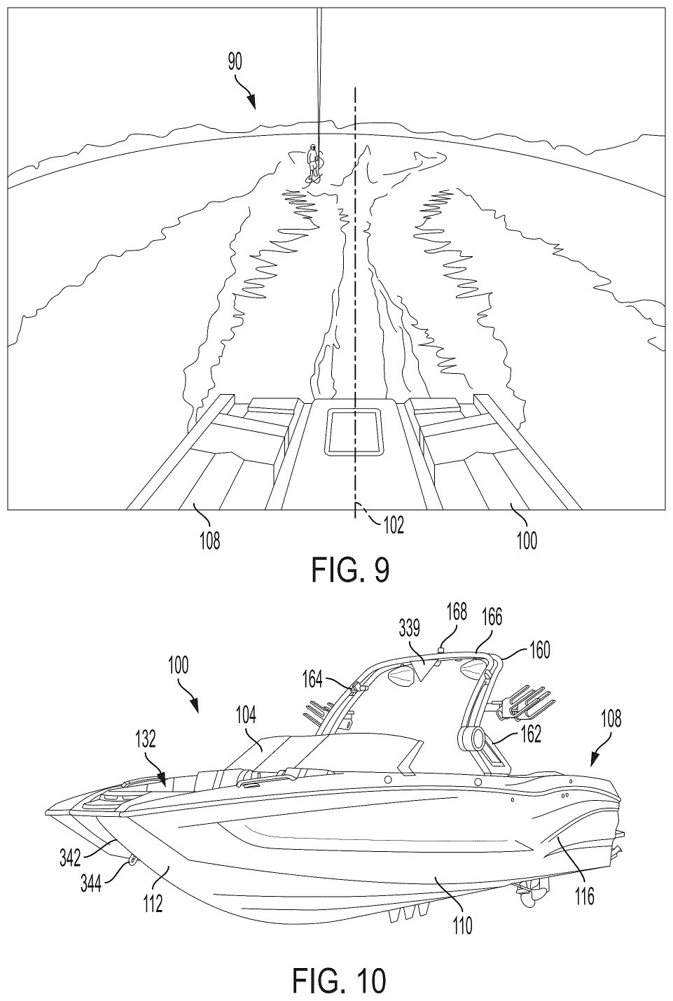

FIG. 7A is an image captured by the port aft-facing camera 331, and FIG. 7B is an image captured by the starboard aft-facing camera 333. When the boat 100 is moved through the water using the propulsion system 200, as discussed above, the boat 100 generates a wake 90 (see FIG. 9). The wake 90 may include a port-side wave 92 and a starboard-side wave 94. The port-side wave 92 and the starboard-side wave 94 may also be referred to as a port-side wake and a starboard-side wake. By operating the surf devices 152, 154 as discussed herein, the wake 90 may be made suitable for wakesurfing, generating a surfable wake. In some embodiments, the surfable wake will include both the port-side wave 92 and the starboard-side wave 94 being suitable for wakesurfing, but in other embodiments, one side of the wake (one of the port-side wave 92 and the starboard-side wave 94) may be suitable for wakesurfing while the other side is less suitable or not suitable for wakesurfing. As can be seen in FIG. 7A, the starboard-side wave 94 is suitable for wakesurfing and is pushing a surfer 96 and, more specifically, a surfboard 98 of the surfer 96 forward with the starboard-side wave 94 of the surfable wake. As can be seen in FIG. 7B, the port-side wave 92 is suitable for wakesurfing and is pushing a surfer 96 and, more specifically, a surfboard 98 of the surfer 96 forward with the starboard-side wave 94 of the surfable wake. The side or sides of the boat 100 with the desirable wave for wakesurfing is referred to as a surf side.

Surfing and foiling are typically done near the boat 100, and as a result, the field of view of each of the port aft-facing camera 331 and the starboard aft-facing camera 333 is set to capture and focus on a surfer or foiler relatively close to the boat 100, preferably from 3 feet to 60 feet behind the transom 114 of the boat 100. If the field of view is tailored to wake surfing, the field of view may be from 3 feet to 60 feet behind the transom 114 of the boat 100, and if the field of view is tailored to foiling, the file of view may be from 20 feet to 60 feet behind the transom of the boat 100. In this embodiment, each of the port aft-facing camera 331 and the starboard aft-facing camera 333 is positioned on the transom 114, above the waterline of the boat 100 and at a level higher than the swim platform 106. The port aft-facing camera 331 is positioned at a level lower than the port gunwale 122, and the starboard aft-facing camera 333 is positioned at a level lower than the starboard gunwale 124. In some embodiments, the elevation of the port gunwale 122 and the starboard gunwale 124 for the purpose of positioning the camera is taken at the aftmost location nearest the transom 114. The port aft-facing camera 331 and the starboard aft-facing camera 333 also can be positioned lower than the sheerline 126 and rub rail 128.

Preferably, the port aft-facing camera 331 and the starboard aft-facing camera 333 are positioned to capture the full height of a typical surfer 96 and may be positioned to capture the surfboard 98. Positioning the port aft-facing camera 331 and the starboard aft-facing camera 333 too low on the transom 114 may require the port aft-facing camera 331 and the starboard aft-facing camera 333 to be angled to such a degree that a portion of the surfer 96 and or the surfboard 98 is omitted from the field of view. Each of the port aft-facing camera 331 and the starboard aft-facing camera 333 may thus be positioned from 9 inches to 28 inches above the top surface of the swim platform 106, such as for example about 18 inches above the top surface of the swim platform 106. Additionally or alternatively, each of the port aft-facing camera 331 and the starboard aft-facing camera 333 may be positioned from 1 inch to 30 inches below the sheerline 126 or rub rail 128, such as for example about 7 inches below the sheerline 126 or rub rail 128.

As noted above, the boat 100 may have an angle of attack (bow rise) when used for surfing. The transom 114 of the boat may thus be angled to face downward toward the water when the boat 100 has an angle of attack. Placing the port aft-facing camera 331 and the starboard aft-facing camera 333 flush on the transom 114 may result in the port aft-facing camera 331 and the starboard aft-facing camera 333 cutting off a portion of the surfer 96 when the boat 100 has an angle of attack. Each of the port aft-facing camera 331 and the starboard aft-facing camera 333 is thus preferably angled upward relative to a top surface of the swim platform 106. When angles or positions of cameras are discussed herein, such angles or positions may be taken relative to a centerline of the lens extending in the direction of the image being captured. Preferably, each of the port aft-facing camera 331 and the starboard aft-facing camera 333 is angled upward from 10 degrees to 30 degrees relative to top surface of the swim platform 106, such as, for example about 20 degrees relative to top surface of the swim platform 106. These angles can also be taken relative to the floor 121.

Each of the port aft-facing camera 331 and the starboard aft-facing camera 333 is preferably positioned to place the surfer, when located at a typical surfing position on the wake, in the center of the field of view. Preferably, the port aft-facing camera 331 and the starboard aft-facing camera 333 are positioned to give view directly toward the face of the surfer 96. With the port-side wave 92 and the starboard-side wave 94 diverging outboard from the centerline 102, the surfer 96 generally faces in a somewhat inward direction. Thus, each of the port aft-facing camera 331 and the starboard aft-facing camera 333 is angled obliquely relative to the centerline 102 of the boat 100. More specifically, each of the port aft-facing camera 331 and the starboard aft-facing camera 333 is angled outboard relative to the centerline. The oblique angle of each of the port aft-facing camera 331 and the starboard aft-facing camera 333 may be from −10 degrees to 30 degrees relative to the centerline. The negative angle indicates an inward facing angle. When outward angles are considered, the port aft-facing camera 331 and the starboard aft-facing camera 333 may angle outwardly at an oblique angle (greater than 0 degrees) that is 30 degrees or less.

With the port-side wave 92 and the starboard-side wave 94 diverging in the manner discussed above, the port aft-facing camera 331 is preferably positioned closer to the centerline 102 of the boat 100 than the port side 116 of the hull 110, and similarly, the starboard aft-facing camera 333 is preferably positioned closer to the centerline 102 than the starboard side 118 of the hull 100. For example, the port aft-facing camera 331 may be located within one quarter of the beam width at the transom 114 on the port side of the centerline 102 of the boat 100, and the starboard aft-facing camera 333 may be located within one quarter of the beam width at the transom 114 on the starboard side of the centerline 102 of the boat 100.

As shown in FIG. 6, the boat 100 of this embodiment includes a pair of aft-facing seats 136 one on the port side of the centerline 102 of the boat 100 and the other on the starboard side of the centerline 102 of the boat 100. The boat 100 also includes a stern walkthrough and, more specifically, a stern walkthrough step 138 located at the transom. Each of the port aft-facing camera 331 and the starboard aft-facing seat can be outboard of the stern walkthrough step 138. In this embodiment, the port aft-facing camera 331 is positioned between stern walkthrough step 138 and the port aft-facing seat of the pair of aft-facing seats 136, and the starboard aft-facing camera 333 is positioned between stern walkthrough step 138 and the starboard aft-facing seat of the pair of aft-facing seats 136.

As discussed further below, images from both of the port aft-facing camera 331 and the starboard aft-facing camera 333 may be displayed simultaneously and side by side on the center display 171. Such a view gives, effectively a composite aft-facing view. Thus, both the port aft-facing camera 331 and the starboard aft-facing camera 333 may be positioned to capture the centerline 102 as projected (or extended) aft of the boat 100, but preferably positioned to have minimal overlap in the field of view. The port aft-facing camera 331 and the starboard aft-facing camera 333 also are collectively positioned to provide, preferably, a view that is at least 180 degrees behind the boat 100. Thus, with the overlap discussed above, each of the port aft-facing camera 331 and the starboard aft-facing camera 333 has a field of view that is at least 90 degrees. In other embodiments, each of the port aft-facing camera 331 and the starboard aft-facing camera 333 has a field of view that is at least 45 degrees, such as at least 60 degrees.

As discussed above, the port aft-facing camera 331 and the starboard aft-facing camera 333 are positioned to have a good view of the wake surfer. The controller 310 in this embodiment is thus configured to selectively display images from one of the port aft-facing camera 331 or the starboard aft-facing camera 333 on the center display 171 in response to the user selecting a user-selectable element for a water sport, such as a surf profile or the surf mode button. More specifically, the controller 310 is configured to display on the center display 171 images from the port aft-facing camera 331 when a user-selectable element for a port-side water sport, such as a surf left profile, is selected, and the controller 310 is configured to display on the center display 171 images from the starboard aft-facing camera 333 when a user-selectable element for a starboard-side water sport, such as a surf right profile, is selected. In some embodiments, when the controller 310 displays images from the port aft-facing camera 331 on the center display 171 in response to the selection of a surf left profile, the controller 310 does not display images from the starboard aft-facing camera 333 on the center display 171. Likewise, in some embodiments, when the controller 310 displays images from the starboard aft-facing camera 333 on the center display 171 in response to the selection of a surf right profile, the controller 310 does not display images from the port aft-facing camera 331 on the center display 171. The controller 310 thus can be configured to selectively display images from only one of the port aft-facing camera 331 and the starboard aft-facing camera 333 on the center display 171 in response to the user selecting a user-selectable element for a water sport.

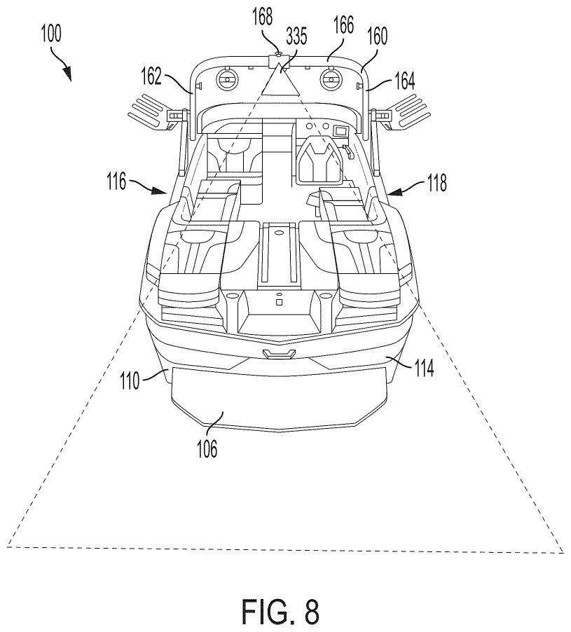

FIG. 8 is a stern view of the boat 100, showing the aft-facing tower camera 335 (central aft-facing camera) mounted on the boat 100. FIG. 8 also schematically illustrates the field of view of the aft-facing tower camera 335. As noted above, wake surfing and foiling typically occur close to the stern 108 of the boat 100, but in other water sports, such as wakeboarding, water skiing, and tubing, the water-sports participant is further from the transom 114. Wakeboarding often occurs with the water-sports participant at distances from 45 feet to 80 feet behind the transom of the boat 100. Water skiing often occurs with the water-sports participant at distances from 40 feet to 75 feet behind the transom of the boat 100. Tubing often occurs with the water-sports participant(s) at distances from 40 feet to 80 feet behind the transom of the boat 100. In addition, the water-sports participant(s) may be a large distance from the centerline 102 and moving quickly from one side to the other, such as a slalom skier that moves between buoys that are more than 38 feet from the centerline 102 of the boat 100. The field of view discussed above for the port aft-facing camera 331 and the starboard aft-facing camera 333 may not be sufficient to monitor the water-sports participant(s) engaged in these sports. Thus, the boat 100 preferably includes another aft-facing camera (aft-facing tower camera 335) positioned with a field of view to cover these sports.

Preferably, this aft-facing camera (the aft-facing tower camera 335) is preferably located at an elevated position, and in this embodiment, the aft-facing tower camera 335 is located on the tower 160 of the boat 100 and, more specifically, on the header 166 of the tower 160. Positioning the aft-facing tower camera 335 on the tower 160 and, more specifically, on the header 166, provides the aft-facing tower camera 335 with a wide and deep field of view behind the boat 100. The aft-facing tower camera 335 also is preferably centrally located on the boat 100. The aft-facing tower camera 335 may be located within one eighth of the beam width on either side of the centerline 102 of the boat 100 and, more specifically in this embodiment, located within a center region of the header 166. As used herein, the center region of the header 166 can be the portion of the header 166 that is one eighth of the beam width on either side of the centerline 102 of the boat 100. In this embodiment, the aft-facing tower camera 335 is aligned with the centerline 102 of the boat 100 and positioned on the header 166 near the towline attachment structure 168 on the tower 160.

FIG. 9 is an image captured by the aft-facing tower camera 335. As discussed above, the aft-facing tower camera 335 is positioned to have a good view of the water-sports participant for other water sports, such as wakeboarding, water skiing, and tubing. Preferably, the aft-facing tower camera 335 has a field of view that that is at least 45 degrees aft of the boat 100, such as at least 60 degrees aft of the boat. In some embodiments, the aft-facing tower camera 335 has a field of view that is 180 degrees or less aft of the boat 100.

The controller 310 in this embodiment is thus configured to selectively display images from the aft-facing tower camera 335 on the center display 171 in response to the user selecting a user-selectable element for a water sport (a third water sport), such as a water-sport mode button (e.g., wakeboarding mode button or ski mode button), a wakeboarding profile, and/or a ski profile. In some embodiments, when the controller 310 displays images from the aft-facing tower camera 335 in response to the selection of the at least one user-selectable element for the third water sport, the controller 310 does not display images from either of the port aft-facing camera 331 or the starboard aft-facing camera 333 on the center display 171. The controller 310 thus can be configured to selectively display images from only one aft-facing camera of the plurality of aft-facing cameras, such as only one of the port aft-facing camera 331, the starboard aft-facing camera 333, and the aft-facing tower camera 335, on the center display 171, in response to the user selecting a user-selectable element for a water sport.

As discussed above, the boat 100 includes a reverse control, such as the control lever 212, that is operable to engage the motor (e.g., the engine 210) with the propulsor (e.g., the propeller 220 through the drive shaft 222 and reverse gear 218) to move the boat in an aft direction. To assist the driver of the boat 100 in operating the boat 100 in reverse, the controller 310 is configured to display on the center display 171 images from at least one of the plurality of aft-facing cameras, such as at least one of the port aft-facing camera 331, the starboard aft-facing camera 333, and the aft-facing tower camera 335, when the reverse control is operated to engage the motor with the propulsor to move the boat in an aft direction, such as by moving the control lever 212 to a reverse position. In reverse, the driver will typically desire a wider field of view than is provided by just one of the port aft-facing camera 331 or the starboard aft-facing camera 333, and preferably, the controller 310 is configured to display images from the aft-facing tower camera 335 on the center display 171 when the control lever 212 is moved to a reverse position. Alternatively (or additionally) the controller 310 may be configured to display images from both of the port aft-facing camera 331 and the starboard aft-facing camera 333 on the center display 171 when the control lever 212 is moved to a reverse position. Preferably, the images from the port aft-facing camera 331 are displayed on the center display 171 at a position that is in a port direction relative to the images from the starboard aft-facing camera 333, and the images from starboard aft-facing camera 333 are displayed on the center display 171 at a position that is in a starboard direction relative to the images from the port aft-facing camera 331. The center display 171 can have a centerline dividing the center display 171 into a port side and a starboard side relative to the centerline of the center display 171. In some embodiments, the images of the port aft-facing camera 331 are displayed on the port side of the center display 171 relative to the centerline of the center display 171 and images from the starboard aft-facing camera 333 are displayed on the starboard side of the center display 171 relative to the centerline of the center display 171. In some embodiments, when images from both of the port aft-facing camera 331 and the starboard aft-facing camera 333 are displayed on the center display 171, the images may be combined together by the controller 310 to create a single image that can act as a single rear view image, using for example a stitching process. While described with reference to placing the control lever 212 is moved to a reverse position, the composite image from both the port aft-facing camera 331 and the starboard aft-facing camera 333, whether stitched or displayed next to each other, may be used in the other instances discussed herein when images from the port aft-facing camera 331 or the starboard aft-facing camera 333 are displayed on the center display 171.

As noted above, the driver's view forward can also be impeded, and the cameras 330 discussed herein can also be used to help improve visibility and awareness for the driver of the environment forward of the boat 100. The boat 100 may thus include at least one forward-facing camera (e.g., bow camera 337 or forward-facing tower camera 339) positioned on the boat to have a field of view of an environment forward of the bow of the boat and configured to generate images of the environment forward of the bow of the boat 100. As noted, above, the boat 100 of this embodiment is a bowrider having a bow seating area 132 positioned forward of the control console 170. Individuals may be seated or otherwise located in the bow seating area 132 and they may impede the driver's view. Additionally, for some water sports, such as wake surfing, the boat 100 may have a large bow rise (high angle of attack) and thus the bow rise impedes the view directly forward of the boat 100. The forward-facing camera (e.g., bow camera 337 or forward-facing tower camera 339) is thus preferably positioned on the boat 100 to provide images of the environment forward of the bow 112 that are not obstructed by the occupants of the bow seating area 132 and to provide images of the environment forward of the bow 112 that may be difficult to see because of the bow rise.

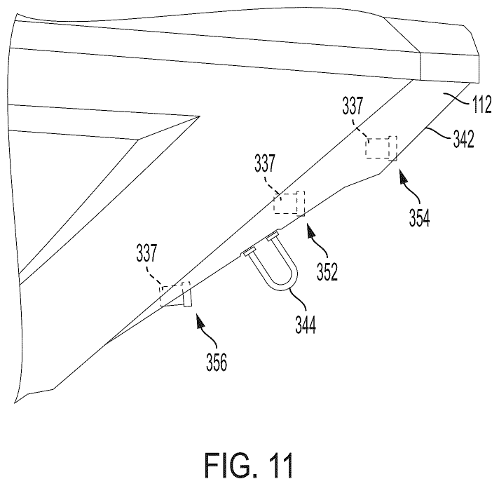

FIG. 10 is a forward view of the boat 100, showing a position of a forward-facing tower camera 339. The forward-facing camera may be located at an elevated position, and in this embodiment, the forward-facing tower camera 339 is located on the tower 160 of the boat 100 and, more specifically, on the header 166 of the tower 160. Positioning the forward-facing tower camera 339 on the tower 160 and, more specifically, on the header 166, provides the forward-facing tower camera 339 with a wide and deep field of view forward of the boat 100. This elevated position on the tower 160 is also high enough to avoid (or at least minimize) obstructions from occupants of the boat 100, such as occupants in the bow seating area 132. Also, the higher the forward-facing tower camera 339 is placed, the closer to the bow 112 the camera can image when the boat 100 has a large angle of attack.

As with the aft-facing tower camera 335, the forward-facing tower camera 339 is preferably centrally located on the boat 100. The forward-facing tower camera 339 may be located within one eighth of the beam width on either side of the centerline 102 of the boat 100 and, more specifically in this embodiment, located within the center region of the header 166. In this embodiment, the forward-facing tower camera 339 is aligned with the centerline 102 of the boat 100 and positioned on the header 166 near the towline attachment structure 168 on the tower 160. The forward-facing tower camera 339 thus may be positioned on the opposite side of the header 166 from the aft-facing tower camera 335.

FIG. 11 is a side view of the bow 112 of the boat 100, showing possible positions of the aft-facing tower camera 335. As noted above, the forward-facing camera can, alternatively (or additionally), be located in the hull 110 on the bow 112 or attached thereto, such as directly attached to the hull 110. The bow 112 can include a leading edge 342 (see also FIG. 10), which may be coincident with the centerline 102 of the boat 100. The bow camera 337 may be located at the leading edge 342 and aligned with the centerline 102 of the boat 100. The bow camera 337 may, however, be offset to one of the port side or the starboard side from the centerline 102 to avoid interfering with various boat operations. The bow camera 337 may be located in a center region of the bow 112. As used herein, the center region of the bow 112 can be one eighth of the maximum beam width on either side of the centerline 102 of the boat 100.

The boat 100 may include a ring 344 (also referred to as a bow eye) located on the leading edge 342 of the bow 112 (see also FIG. 10). The ring 344 may be used to secure the boat 100 on a trailer and help load the boat 100 on the trailer. For example, the trailer may have a winch post having a winch and a boat stop. The winch may include a cable and a hook that can be attached to the ring 344 to pull the boat 100 onto the trailer during loading and to secure the boat 100 on the trailer once loaded. When fully loaded onto the trailer, the bow 112 of the boat 100 and, more specifically, the leading edge 342 of the bow 112 may contact the boat stop. With the bow camera 337 offset from the centerline 102, as discussed above, the bow camera 337 avoids contact with the boat stop and may be positioned to avoid (or minimize) the ring 344 obstructing the field of view of the bow camera 337.

Three different elevation positions for the bow camera 337 are shown in FIG. 11, and these may be alternate positions of the bow camera 337. A first position 352 and a second position 354 are located above the ring 344, thereby avoiding any obstruction in the field of view from the ring 344. A third position 356 is positioned below the ring 344.

If the bow camera 337 is not offset from the centerline 102, the bow camera 337 may be located at the second position 354 or the third position 356 to avoid contact with the boat stop while on the trailer, which could damage the bow camera 337. The bow camera 337 may be located at the first position 352 or the third position 356 for an improved view of the environment directly in front of the bow 112, when the boat 100 has a high angle of attack.

An advantage of positioning the bow camera 337 in the third position 356 is that the ring 344 may be used as a reference point. With the bow camera 337 in the third position, the bow camera 337 may be positioned to include at least a portion of the ring 344 in the field of view. The ring 344 thus provides a reference point indicating the centerline of the boat within the field of view for the operator to maneuver the boat 100 and help align the boat 100, such as during trailering and the like.

With the forward-facing camera (e.g., the bow camera 337 or forward-facing tower camera 339) located as discussed above, the forward-facing camera (e.g., the bow camera 337 or forward-facing tower camera 339) can be used to mitigate the effects of bow rise. The controller 310 in this embodiment is thus configured to selectively display images from the forward-facing camera (e.g., the bow camera 337 or forward-facing tower camera 339) on the center display 171 in response to the user selecting a user-selectable element for a water sport, such as a water-sport mode button (e.g., surf mode button, wakeboarding mode button or ski mode button), surf left profile, a surf right profile, a wakeboarding profile, and/or a ski profile. In addition, the forward-facing camera (e.g., the bow camera 337 or forward-facing tower camera 339) during other operations of the boat 100, and the controller 310 may also be configured to selectively display images from the forward-facing camera (e.g., the bow camera 337 or forward-facing tower camera 339) on the center display 171 in response to the user selecting a user-selectable element for a non-sport mode, such as the drive mode button. The controller 310 may also be configured to selectively display images from the forward-facing camera (e.g., the bow camera 337 or forward-facing tower camera 339) on the center display 171 when the control system 300 otherwise enters the drive mode.

As discussed above, more than one camera 330 may be improve the visibility and awareness for the driver during certain activities or operations. For example, both the forward-facing camera (e.g., the bow camera 337 or forward-facing tower camera 339) and one of the aft-facing cameras (e.g., the port aft-facing camera 331, the starboard aft-facing camera 333, or the aft-facing tower camera 335) may be useful to improve the visibility and awareness for the driver during water sports. The controller 310 thus can be configured to configured to selectively display images from both the forward-facing camera (e.g., the bow camera 337 or forward-facing tower camera 339) and one of the aft-facing cameras (e.g., the port aft-facing camera 331, the starboard aft-facing camera 333, or the aft-facing tower camera 335) on the center display 171 in response to the user selecting a user-selectable element, such as a user-selectable element for a water sport.

More specifically, the controller 310 can be configured to display on the center display 171 images from the forward-facing camera (e.g., the bow camera 337 or forward-facing tower camera 339) and one of the port aft-facing camera 331 or the starboard aft-facing camera 333 in response to response to the user selecting a user-selectable element for a wake surfing, such as the wake mode button, a surf left profile, or a surf right profile. Even more specifically, the controller 310 can be configured to display on the center display 171 images from the forward-facing camera (e.g., the bow camera 337 or forward-facing tower camera 339) and the port aft-facing camera 331 in response to response to the user selecting a surf left profile, and the controller 310 can be configured to display on the center display 171 images from the forward-facing camera (e.g., the bow camera 337 or forward-facing tower camera 339) and the starboard aft-facing camera 333 in response to response to the user selecting a surf right profile.

The controller 310 also can be configured to display on the center display 171 images from the forward-facing camera (e.g., the bow camera 337 or forward-facing tower camera 339) and the aft-facing tower camera 335 in response to response to the user selecting a user-selectable element for another water sport (third water sport) such as a water-sport mode button (e.g., wakeboarding mode button or ski mode button), a wakeboarding profile, and/or a ski profile. When images from two (or more) cameras 330 are displayed on the center display 171, these images may be displayed simultaneously.

The cameras 330 discussed herein, and particularly those used for monitoring the water-sports participant, such as the port aft-facing camera 331, the starboard aft-facing camera 333, and the aft-facing tower camera 335, can include pan, tilt, and zoom features. Such features may be manually controlled, or the camera may be moveable by a suitable movement mechanism, such as a motor or actuator for pan and tilt, for example. However, such pan, tilt, and zoom features may also be implemented as digital pan, tilt, and zoom, where the processor 312 executes an image processing analysis to digitally zoom or change the field of view displayed on the center display 171. In some embodiments, the processor 312 can execute an object recognition process, utilizing, for example, an artificial neural network that has been trained to identify the water-sports participant (e.g., the surfer 96) and/or other objects indictive of the water-sports participant such as water-sports equipment like the surfboard 98. The processor 312 can thus adjust the portion of the image captured by the cameras 330 to have the desired zoom and/or track the water-sports participant based on the image processing analysis.

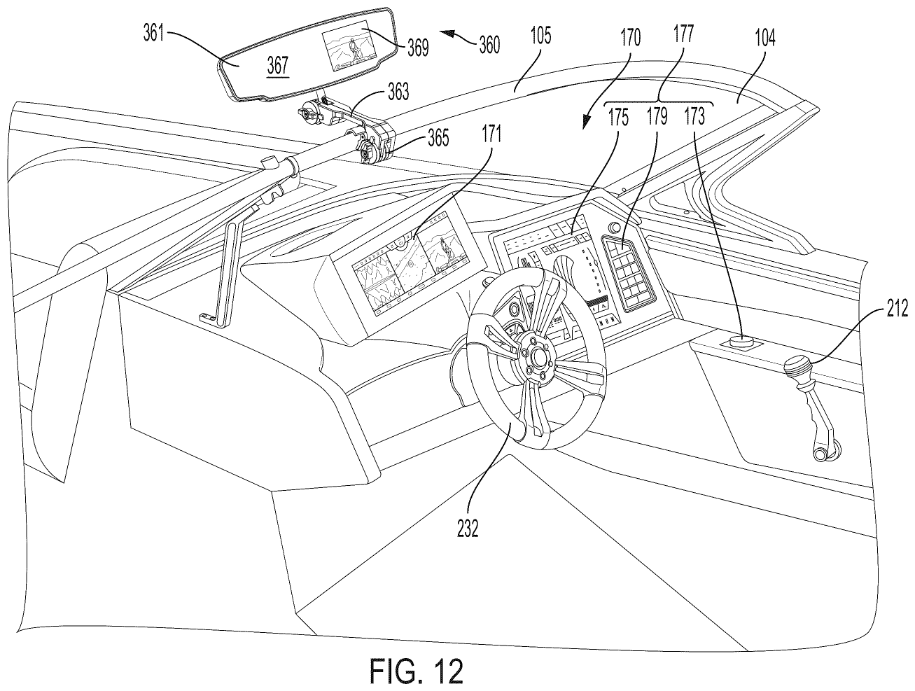

As discussed above, the controller 310 is configured to selectively display images from the various cameras 330 on a display screen. The center display 171 is the example display screen discussed above, but the display screen is not so limited and the controller 310 can be configured to display the images on other suitable display screens. FIG. 12 is a perspective view of the control console 170 including a mirror assembly 360. The mirror assembly 360 includes a includes a mirror 361, a support 363, and mounting structure 365. In this embodiment, the mounting structure 365 is used to mount the mirror assembly 360 to a top edge 105 of the windshield 104. The support 363 connects the mirror 361 to the mounting structure 365. Any suitable mirror assembly may be used, including, for example, the adjustable mirror assembly disclosed in U.S. Pat. No. 11,175,476, which is incorporated by reference herein in its entirety.

The mirror 361 includes a reflective surface 367 and a display screen 369. The display screen 369 sized to fit behind the reflective surface 367 within a housing of the mirror 361 and may be, for example, and light emitting diode (LED) display screen. The reflective surface 367 may be any suitable mirror material, but in this embodiment, it is a reflective glass that allows light (and thus the images) from the display screen 369 through the reflective surface 367 when the display screen 369 is turned on or otherwise activated. The display screen 369 is communicatively coupled to the controller 310 and one or more of the cameras 330 in the manner discussed above. The controller 310 may be configured to selectively turn on the display screen 369 and display images from at least one of the cameras 330, preferably the aft-facing cameras (e.g., the port aft-facing camera 331, the starboard aft-facing camera 333, or the aft-facing tower camera 335) in the manner described above.

Although this invention has been described with respect to certain specific exemplary embodiments, many additional modifications and variations will be apparent to those skilled in the art in light of this disclosure. It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

What is claimed is:

1. A boat comprising:
a stern;
a plurality of aft-facing cameras, each aft-facing camera of the plurality of aft-facing cameras being positioned on the boat to have a field of view of at least an environment aft of the stern of the boat and configured to generate images of the environment aft of the stern of the boat, one camera of the plurality of aft-facing cameras being a port aft-facing camera positioned on a port side of centerline of the boat, another camera of the plurality of aft-facing cameras being a starboard aft-facing camera positioned on a starboard side of centerline of the boat;
a display screen communicatively coupled to each of the port aft-facing camera and the starboard aft-facing camera to selectively display images from the port aft-facing camera and the starboard aft-facing camera;
an input device including at least one user-selectable element for a port-side water sport and at least one user-selectable element for a starboard-side water sport; and
a controller communicatively coupled to the input device and the display screen, the controller being configured to display, on the display screen, images from one of the port aft-facing camera or the starboard aft-facing camera, the controller being configured to display, on the display screen, (i) images from the port aft-facing camera when the at least one user-selectable element for the port-side water sport is selected, and (ii) images from the starboard aft-facing camera when the at least one user-selectable element for the starboard-side water sport is selected.

2. The boat of claim 1, further comprising a control console including the display screen.

3. The boat of claim 1, further comprising a mirror including the display screen.

4. The boat of claim 3, further comprising a windshield and a mirror assembly mounted to the windshield, wherein the mirror assembly includes the mirror.

5. The boat of claim 1, further comprising a hull, the hull including a transom, wherein each of the port aft-facing camera and the starboard aft-facing camera is mounted on the transom.

6. The boat of claim 5, wherein each of the port aft-facing camera and the starboard aft-facing camera have an overlapping field of view.

7. The boat of claim 6, wherein the overlapping field of view includes the centerline extended aft of the stern of the boat.

8. The boat of claim 6, wherein collectively the port aft-facing camera and the starboard aft-facing camera have a field of view that is at least 180 degrees.

9. The boat of claim 5, further comprising a swim platform, wherein each of the port aft-facing camera and the starboard aft-facing camera is positioned on the transom at a level higher than the swim platform.

10. The boat of claim 9, further comprising a hull including a port side and a starboard side, the port side having port gunwale and the starboard side having a starboard gunwale, wherein the port aft-facing camera is positioned at a level lower than the port gunwale, and the starboard aft-facing camera is positioned at a level lower than the starboard gunwale.

11. The boat of claim 9, wherein each of the port aft-facing camera and the starboard aft-facing camera is angled upward relative to a top surface of the swim platform.

12. The boat of claim 5, wherein each of the port aft-facing camera and the starboard aft-facing camera is angled obliquely relative to the centerline.

13. The boat of claim 12, wherein each of the port aft-facing camera and the starboard aft-facing camera is angled outboard relative to the centerline.

14. The boat of claim 5, further comprising a hull including a port side and a starboard side, wherein the port aft-facing camera is positioned closer to the centerline than the port side of the hull, and the starboard aft-facing camera is positioned closer to the centerline than the starboard side of the hull.

15. The boat of claim 14, wherein the port aft-facing camera is located within one quarter of the beam width at the transom on the port side of the centerline, and the starboard aft-facing camera is located within one quarter of the beam width at the transom on the starboard side of the centerline.

16. The boat of claim 5, further comprising:
a pair of aft-facing seats including a port aft-facing seat and a starboard aft-facing seat; and
a stern walkthrough step, the port aft-facing camera being positioned between stern walkthrough step and the port aft-facing seat, and the starboard aft-facing camera being positioned between stern walkthrough step and the starboard aft-facing seat.

17. The boat of claim 1, wherein the port-side water sport is wake surfing and the at least one user-selectable element for the port-side water sport is a user-selectable element to configure the boat for surfing on the port side of the boat, and
wherein the starboard-side water sport is wake surfing and the at least one user-selectable element for the starboard-side water sport is a user-selectable element to configure the boat for surfing on the starboard side of the boat.

18. The boat of claim 1, wherein the plurality of aft-facing cameras includes a central aft-facing camera, the input device includes at least one user-selectable element for a third water sport, and the controller is configured to display, on the display screen, images from the central aft-facing camera when the at least one user-selectable element for the third water sport is selected.

19. The boat of claim 18, further comprising a tower, wherein the central aft-facing camera is located on the tower.

20. The boat of claim 19, wherein the tower includes a header and the central aft-facing camera is located on a central portion of the header.

21. The boat of claim 1, wherein the plurality of aft-facing cameras includes a central aft-facing camera,
wherein the input device is a control screen, a plurality of controls is displayable on the control screen, and the plurality of controls include a plurality of mode buttons, and
wherein the controller includes a processor and a memory,
the memory having stored therein a plurality of modes, with each mode corresponding to an activity and including a subset of the plurality of controls corresponding to the activity, and one of the modes of the plurality of modes being a water-sport mode corresponding to a third water sport,
the controller being configured to display on the control screen, when one of the modes is activated, the subset of the plurality of controls for the activated mode, the mode being activated when a corresponding one of the mode buttons is selected, and
wherein the controller is configured to display, on the display screen, images from the central aft-facing camera when a mode button of the plurality of mode buttons corresponding to the third water sport is selected.

22. The boat of claim 1, further comprising:
a hull including a bow; and
a forward-facing camera positioned on the boat to have a field of view of an environment forward of the bow of the boat and configured to generate images of the environment forward of the bow of the boat,
wherein the display screen is communicatively coupled to the forward-facing camera to selectively display images from the forward-facing camera, and
wherein the controller is configured to display, on the display screen, (i) images from the forward-facing camera when the at least one user-selectable element for the port-side water sport is selected, and (ii) images from the forward-facing camera when the at least one user-selectable element for the starboard-side water sport is selected.

23. A boat comprising:
a hull including a bow;
a forward-facing camera positioned on the boat to have a field of view of an environment forward of the bow of the boat and configured to generate images of the environment forward of the bow of the boat;
a control console including a display screen, the display screen being communicatively coupled to the forward-facing camera to selectively display images from the forward-facing camera;
an input device including at least one user-selectable element for a water sport; and
a controller communicatively coupled to the input device and the display screen, the controller including a processor and a memory, and the controller being configured to display on the display screen, when the at least one user-selectable element for the water sport is selected, images from the forward-facing camera.

24. The boat of claim 23, wherein the forward-facing camera is located on the bow of the boat.

25. The boat of claim 24, wherein the forward-facing camera is aligned with a centerline of the boat.

26. The boat of claim 24, wherein the forward-facing camera is offset from a centerline of the boat within a central portion of the bow.

27. The boat of claim 23, further comprising a tower, wherein the forward-facing camera is located on the tower.

28. The boat of claim 27, wherein the tower includes a header, and the forward-facing camera is located on a central portion of the header.

29. A boat comprising:
a stern;
a propulsion system including a motor and a propulsor, the motor being engageable with the propulsor to move the boat in an aft direction;
a reverse control operable to engage the motor with the propulsor to move the boat in an aft direction;
an aft-facing camera positioned on the boat to have a field of view of an environment aft of the stern of the boat and configured to generate images of the environment aft of the stern of the boat;
a display screen communicatively coupled to the aft-facing camera to selectively display images from the aft-facing camera; and
a controller communicatively coupled to the display screen, the controller being configured to display, on the display screen, images from the aft-facing camera when the reverse control is operated to engage the motor with the propulsor to move the boat in an aft direction.

30. The boat of claim 29, wherein the reverse control is a control lever moveable from a neutral position to at least one reverse position, and the controller is configured to display, on the display screen, images from the aft-facing camera when the controller is moved to the at least one reverse position.

31. The boat of claim 29, wherein the aft-facing camera is a central aft-facing camera.

32. The boat of claim 31, further comprising a tower, wherein the central aft-facing camera is located on the tower.

33. The boat of claim 32, wherein the tower includes a header, and the central aft-facing camera is located on a central portion of the header.
